(19) United States
(12) Patent Application Publication
(10) Pub. No.: US 2022/0123486 A1
(43) Pub. Date: Apr. 21, 2022

(54) CONNECTOR

(71) Applicant: YOKOWO CO., LTD., Kita-ku, Tokyo (JP)

(72) Inventors: Fumikazu KOBAYASHI, Tomioka-Shi, Gunma (JP); Nozomu MORITA, Kita-Ku, Tokyo (JP)

(73) Assignee: YOKOWO CO., LTD., Kita-ku, Tokyo (JP)

(21) Appl. No.: 17/424,170

(22) PCT Filed: Oct. 2, 2019
(86) PCT No.: PCT/JP2019/038896

§ 371 Date: Jul. 20, 2021

(30) Foreign Application Priority Data
Jan. 22, 2019 (JP) 2019-008387

(51) Int. Cl. H01R 12/75; H01R 4/16; H01R 4/28

(52) U.S. Cl. CPC H01R 12/75; H01R 4/28; H01R 4/16

(57) ABSTRACT

Provided is a connector capable of firmly maintaining a connection state. A connector 1 includes a first clamp portion 10 having a press receiving portion 11 and a second clamp portion 30 having a press portion 31a. At least one of the press receiving portion 11 and the press portion 31a includes metal. When the second clamp portion 30 is fixed to the first clamp portion 10 or a housing that holds the first clamp portion 10, a linear conductor inserted from one end portion side of the press receiving portion 11 is clamped between the press portion 31a and the press receiving portion 11, comes into contact with the press portion 31a and the press receiving portion 11, and is bent between the one end portion and the press portion 31a.

### TECHNICAL FIELD

The present invention relates to a connector.

### BACKGROUND ART

In the related art, as in Patent Literature 1, a connector used for connecting a connection object such as a substrate with a cable has been proposed.

### CITATION LIST

### Patent Literature

Patent Literature 1: JP 2012-79462 A

### SUMMARY OF INVENTION

### Technical Problem

However, since only pressure bonding is performed by the spring, there is a possibility that a connection state cannot be firmly maintained.

Therefore, an object of the present invention is to provide a connector capable of firmly maintaining the connection state.

### Solution to Problem

A connector according to the present invention includes a first clamp portion having a press receiving portion and a second clamp portion having a press portion. At least one of the press receiving portion and the press portion includes metal. When the second clamp portion is fixed to the first clamp portion or a housing that holds the first clamp portion, a linear conductor inserted from one end portion side of the press receiving portion is clamped between the press portion and the press receiving portion, comes into contact with the press portion and the press receiving portion, and is bent between the one end portion and the press portion.

The linear conductor such as a cable can be fixed to the connector by fixing the second clamp portion to the first clamp portion and clamping the linear conductor between the press portion and the press receiving portion.

At this time, the linear conductor is bent. Therefore, as compared with a form in which a bent region is not provided, it becomes hard to be detached and a connection state can be firmly maintained.

Preferably, the first clamp portion includes an insertion port side protrusion region on the one end portion side, and a rear side protrusion region on the other end portion side of the press receiving portion. The insertion port side protrusion region and the rear side protrusion region extend toward the linear conductor. A region of the press receiving portion coming into contact with the linear conductor is positioned between the insertion port side protrusion region and the rear side protrusion region. When the second clamp portion is fixed to the first clamp portion or the housing, the linear conductor is bent between the insertion port side protrusion region and the press portion, and between the rear side protrusion region and the press portion.

The linear conductor is bent between a distal end side protrusion and the press portion. Therefore, as compared with a form in which a bent region is not provided, it becomes hard to be detached and a connection state can be firmly maintained.

More preferably, a protrusion amount of a region of the insertion port side protrusion region coming into contact with the linear conductor from the press receiving portion is smaller than a protrusion amount of a region of the rear side protrusion region coming into contact with the linear conductor from the press receiving portion.

A distal end portion of the linear conductor can be bent more than the other region. Therefore, the linear conductor cannot be easily removed from a connector 1 as compared with a form in which the linear conductor is not largely bent.

Preferably, the press receiving portion, the insertion port side protrusion region, and the rear side protrusion region include metal. When the second clamp portion is fixed to the first clamp portion or the housing, the linear conductor comes into contact with the press receiving portion, the insertion port side protrusion region, and the rear side protrusion region.

The linear conductor can be brought into contact with the first clamp portion at a plurality of places (the press receiving portion, the insertion port side protrusion region, and the rear side protrusion region). Therefore, connection reliability can be improved as compared with a form in which contact is made at one point.

Preferably, the linear conductor is formed of a stranded wire. A cross section of the region of the press portion coming into contact with the linear conductor as viewed from the one end portion side has a shape covering at least a part of a side portion of the linear conductor. When the second clamp portion is fixed to the first clamp portion or the housing, a distance between a portion farthest from the press receiving portion in a region of the press portion coming into contact with the linear conductor and the press receiving portion is shorter than a diameter of the linear conductor.

The press portion has a shape covering the linear conductor formed of the stranded wire. Therefore, it is possible to prevent the linear conductor from being scattering after being pressed.

Preferably, the linear conductor is formed of a stranded wire. A cross section of the region of the press receiving portion coming into contact with the linear conductor as viewed from the one end portion side has a shape covering at least one of side portions of the linear conductor. When the second clamp portion is fixed to the first clamp portion or the housing, a distance between a portion farthest from the press portion in a region of the press receiving portion coming into contact with the linear conductor and the press portion is shorter than a diameter of the linear conductor.

The press receiving portion has a shape covering the linear conductor formed of the stranded wire. Therefore, it is possible to prevent the linear conductor from being scattering after being pressed.

Preferably, the linear conductor is formed of a stranded wire. When the second clamp portion is fixed to the first clamp portion or the housing, a cross section of a region surrounded by the press portion and the press receiving portion as viewed from the one end portion side has a cross-sectional area equal to or larger than a cross-sectional area of a plurality of the stranded wires constituting the linear conductor as viewed from the one end portion side.

Preferably, the first clamp portion includes the insertion port side protrusion region on the one end portion side. The insertion port side protrusion region extends in a direction perpendicular to an extending direction of the linear conductor. A region of the insertion port side protrusion region coming into contact with the linear conductor has a cut-away portion covering the linear conductor.

The cut-away portion of the insertion port side protrusion region has a shape covering the linear conductor formed of the stranded wires. Therefore, it is possible to prevent the linear conductor from being scattering after being pressed.

Preferably, the first clamp portion has a first side portion. The first side portion rotatably holds the second clamp portion.

More preferably, the second clamp portion is fixed to the first clamp portion or the housing by locking. The first clamp portion has a second side portion on a side closer to the one end portion than the first side portion. The second side portion has a protrusion or a recess for locking the second clamp portion.

More preferably, when the second clamp portion is fixed to the first clamp portion or the housing, the second clamp portion covers the first side portion and a side close to the one end portion, and does not cover the second side portion and a side opposite to the side close to one end portion.

An opening is provided between the second clamp portion and the first clamp portion. Therefore, it is possible to confirm an attachment state or the like of the linear conductor before fixing or after fixing.

Preferably, the press receiving portion is fixed to a substrate.

The first clamp portion including the press receiving portion is fixed to the substrate, and the second clamp portion is rotatably held by the first clamp portion. Therefore, the second clamp portion cannot be removed from the substrate, and a loss of the second clamp portion can be prevented.

Preferably, when the second clamp portion is fixed to the first clamp portion or the housing, a central axis of the linear conductor is bent in an S shape or a crank shape between the one end portion and the press portion.

The linear conductor is bent in the crank shape between an insertion port side protrusion and the press portion. Therefore, as compared with a form in which a region bent in the crank shape is not provided, it becomes hard to be detached and the connection state can be firmly maintained.

Preferably, the linear conductor is removable.

When the fixed state is released, the second clamp portion is separated from the first clamp portion, and the linear conductor can be easily removed from the connector.

Preferably, the first clamp portion includes an insertion port side protrusion region on the one end portion side and a rear side protrusion region on the other end portion side of the press receiving portion. A protrusion amount of a region of the insertion port side protrusion region coming into contact with the linear conductor from the press receiving portion is smaller than a protrusion amount of a region of the rear side protrusion region coming into contact with the linear conductor from the press receiving portion.

Preferably, the first clamp portion includes an insertion port side protrusion region on the one end portion side and a rear side protrusion region on the other end portion side of the press receiving portion. When the second clamp portion is fixed to the first clamp portion or the housing, the linear conductor comes into contact with the press receiving portion, the insertion port side protrusion region, and the rear side protrusion region.

Preferably, the first clamp portion includes an insertion port side protrusion region on the one end portion side and a rear side protrusion region on the other end portion side of the press receiving portion. A protrusion amount of a region of the insertion port side protrusion region coming into contact with the linear conductor from the press receiving portion is smaller than a protrusion amount of a region of the rear side protrusion region coming into contact with the linear conductor from the press receiving portion, and when the second clamp portion is fixed to the first clamp portion or the housing, the linear conductor comes into contact with the press receiving portion, the insertion port side protrusion region, and the rear side protrusion region.

Preferably, openings are provided between the second clamp portion and the first clamp portion and on one end portion side and the other end portion side in the insertion direction of the conductor.

### Advantageous Effects of Invention

As described above, according to the present invention, it is possible to provide a connector capable of firmly maintaining a connection state.

### BRIEF DESCRIPTION OF DRAWINGS

FIG. 1 is a perspective view of a connector of which a second clamp portion is closed, as viewed from a front side in a y direction according to a first embodiment.

FIG. 2 is a perspective view of a connector of which a second clamp portion is closed, as viewed from a rear side in a y direction.

FIG. 3 is a perspective view of a connector in a state in which a second clamp portion is opened, as viewed from a front side in a y direction.

FIG. 4 is a perspective view of a connector in a state in which a cable is inserted and a second clamp portion is opened, as viewed from a rear side in a y direction.

FIG. 5 is a perspective view of a connector which is attached to a substrate and of which a second clamp portion is closed, as viewed from above a rear side in a y direction.

FIG. 6 is a perspective view of a connector in a state in which a cable is inserted, which is attached to a substrate, and in which a second clamp portion is opened, as viewed from above a rear side in a y direction.

FIG. 7 is a perspective view of a connector in a state in which a cable is inserted, which is attached to a substrate, and in which a second clamp portion is closed, as viewed from above a rear side in a y direction.

FIG. 8 is a cross-sectional perspective view of a connector.

FIG. 9 is a cross-sectional configuration diagram of a connector into which a thick cable is inserted.

FIG. 10 is a cross-sectional configuration diagram of a connector into which a thin cable is inserted.

FIG. 11 is a perspective view of a connector and a substrate in a first state.

FIG. 12 is a perspective view of a connector, a substrate, and a cable in a second state.

FIG. 13 is a perspective view of a connector in a second state including a second clamp portion in a cross-sectional perspective view, a substrate, and a cable.

FIG. 14 is a perspective view of a connector, a substrate, and a cable in a third state.

FIG. 15 is a cross-sectional perspective view of a connector according to a second embodiment in a state before a second clamp portion is attached to a housing holding a first clamp portion.

FIG. 16 is a cross-sectional perspective view of a connector according to a second embodiment in a state after a second clamp portion is attached to a housing holding a first clamp portion.

FIG. 17 is a cross-sectional perspective view of a connector according to a third embodiment in a state before a press portion is attached to a first clamp portion.

FIG. 18 is a cross-sectional perspective view of a connector according to a third embodiment, which illustrates a state in which a first clamp portion and a second clamp portion are fixed by a cover.

FIG. 19 is a cross-sectional view of a connector according to a third embodiment, which illustrates regions of a conductor portion, a press receiving portion, and a press portion.

### DESCRIPTION OF EMBODIMENTS

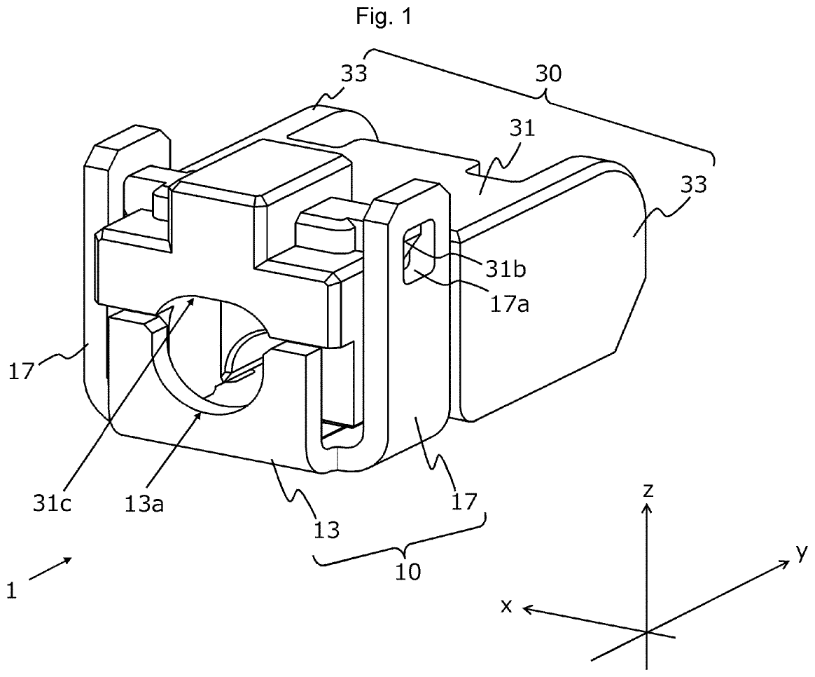

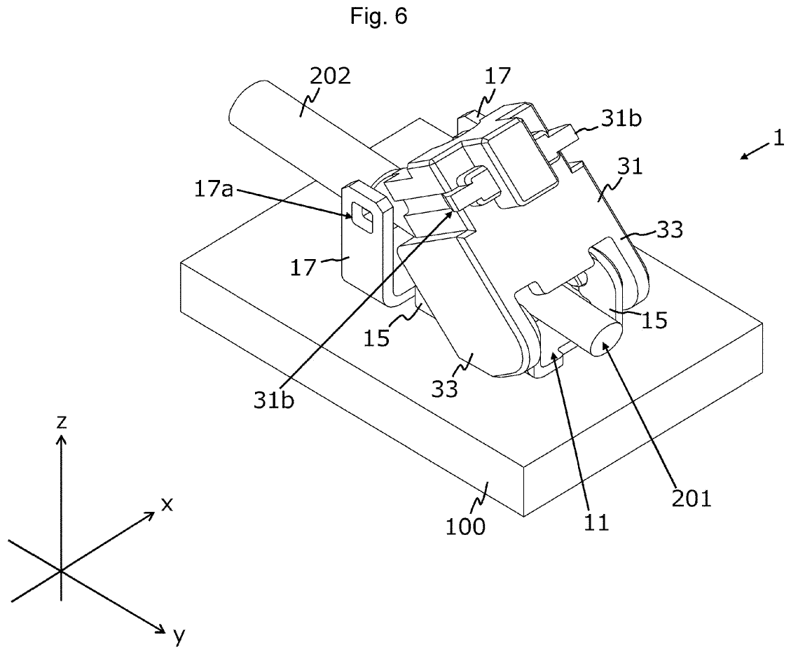

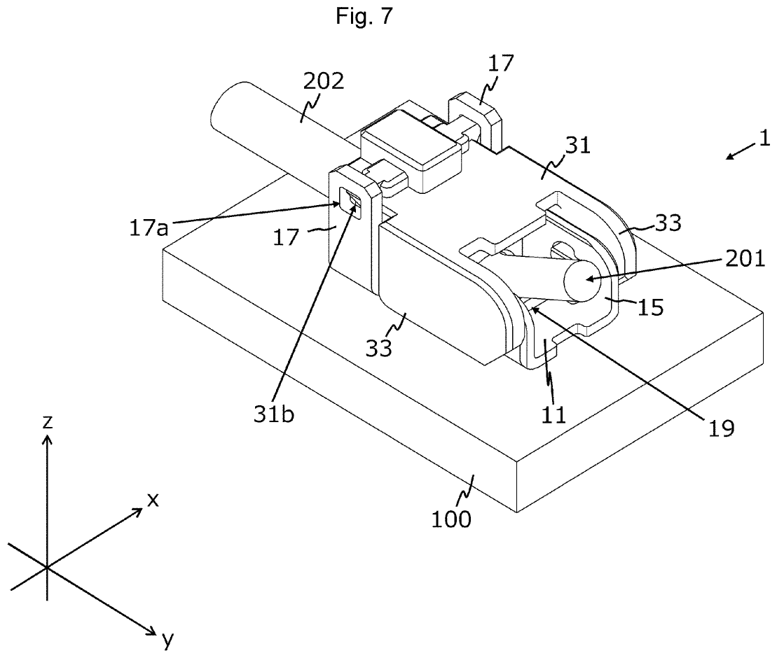

Hereinafter, a first embodiment will be described with reference to FIGS. 1 to 14.

The embodiment is not limited to the following embodiment. The contents described in one embodiment are similarly applied to other embodiments in principle. Each embodiment and each modification example can be appropriately combined.

As illustrated in FIGS. 1 to 3, a connector 1 according to the first embodiment includes a first clamp portion 10 and a second clamp portion 30.

At the time of attachment to the connector 1, an insertion step of inserting a linear conductor such as a cable 200 and a fixing step of clamping and fixing the linear conductor are separately performed. At the time of removal from the connector 1, a releasing step of releasing a state in which the linear conductor such as the cable 200 is clamped and fixed, and a removal step of removing the linear conductor are separately performed.

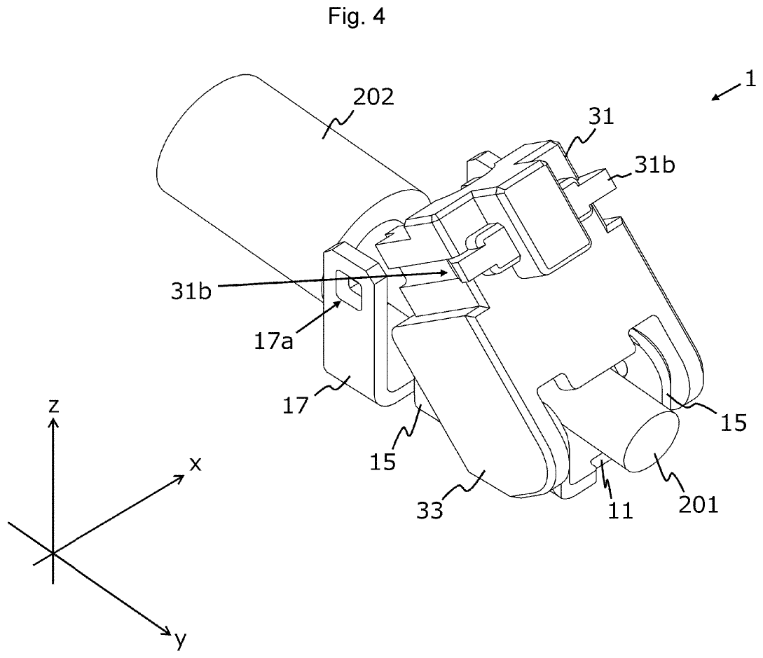

As illustrated in FIG. 4, the connector 1 is used for electrically connecting an electronic device connected to the first clamp portion 10 or the second clamp portion 30 to the cable 200 in a removable state.

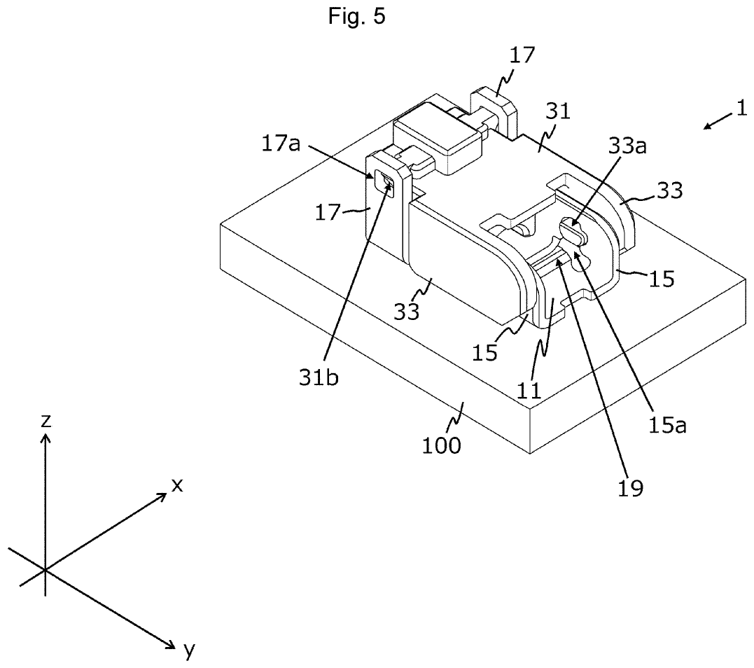

For example, as illustrated in FIGS. 5 to 7, the connector 1 is used for connection between a substrate 100 and the cable 200. An electronic device such as an LED is mounted on the substrate 100. In this case, the connector 1 has a dimension of about 3 mm to 7 mm in length, width, and height.

The cable 200 includes a conductor portion 201, and a protection portion 202. The protection portion 202 is made of an insulation material covering a periphery of the conductor portion 201.

However, the portion inserted into the connector 1 is not covered with the protection portion 202, and the conductor portion 201 is exposed.

An object to be inserted into the connector 1 is not limited to the conductor portion 201 of the cable 200, and may be a linear conductor such as a terminal (foot) extending from an LED element.

The conductor portion 201 may be formed of a single wire or may be formed of a stranded wire.

However, in consideration of being bent by a press portion 31a or the like and being capable of preventing the conductor portion 201 from being scattered by a lower cut-away portion 13a, an effect of the present invention is likely to be obtained from the form in which the conductor portion 201 is formed of the stranded wire.

In order to describe a direction, a horizontal direction (right and left direction) perpendicular to a direction in which the cable 200 is inserted into the connector 1 is defined as an x direction, a direction (front and rear direction) in which the cable 200 is inserted into the connector 1 is defined as a y direction, and a direction (up and down direction) perpendicular to the x direction and the y direction is defined as a z direction.

In FIG. 1, directions indicated by arrows of xyz axes are defined as a left direction, a rear direction, and an upper direction, respectively.

(Description of First Clamp Portion 10)

Next, details of the first clamp portion 10 will be described.

The first clamp portion 10 includes a press receiving portion (bottom surface portion) 11, an insertion port side protrusion region 13, first side portions (side portions for a bearing) 15, second side portions (side portions for engagement) 17, and a rear side protrusion region 19 (see FIGS. 1 to 5).

In the first embodiment, a form will be described in which all the members constituting the first clamp portion 10 are made of metal and said members are integrally formed. However, as long as at least the region of the press receiving portion 11 coming into contact with the conductor portion 201 is made of metal and the conductor portion 201 is electrically connected to the substrate 100, the other portions may be made of a material other than metal.

The press receiving portion 11 has a plane perpendicular to the z direction. The press receiving portion 11 is fixed to the substrate 100 and is electrically connected to the substrate 100 by soldering or the like.

The insertion port side protrusion region 13 has a height in a direction (z direction) which is perpendicular to a direction in which the cable 200 is inserted into the connector 1 and which faces a longitudinal cross section with respect to the extending direction of the conductor portion 201.

Specifically, the insertion port side protrusion region 13 has a plane (xz plane) perpendicular to the y direction. The insertion port side protrusion region 13 is provided on a front side of the first clamp portion 10 in the y direction (on one end portion side of the press receiving portion 11). The insertion port side protrusion region 13 extends toward the conductor portion 201 upward in the z direction from the press receiving portion 11.

In the first embodiment, an example in which the insertion port side protrusion region 13 has a plane (xz plane) perpendicular to the y direction will be described. However, as long as the end portion comes into contact with the conductor portion 201 to fix the conductor portion 201, the insertion port side protrusion region 13 may have another shape, for example, an inclined surface or a curved surface.

The lower cut-away portion 13a is provided at the center in the x direction of an upper portion of the insertion port side protrusion region 13. The lower cut-away portion 13a covers and holds the conductor portion 201 of the cable 200.

In the first embodiment, an example in which the lower cut-away portion 13a has an arc shape as viewed from the y direction is illustrated. However, the lower cut-away portion 13a may have a U shape, a V shape, a recessed shape without one side of a quadrangle, or the like as viewed from the y direction.

By providing the lower cut-away portion 13a, a contact region between the conductor portion 201 of the cable 200 and the insertion port side protrusion region 13 can be widened as compared with a form in which the lower cut-away portion 13a is not provided. By providing the lower cut-away portion 13a, it is possible to prevent the cable 200 from coming off as compared with a form in which the lower cut-away portion 13a is not provided.

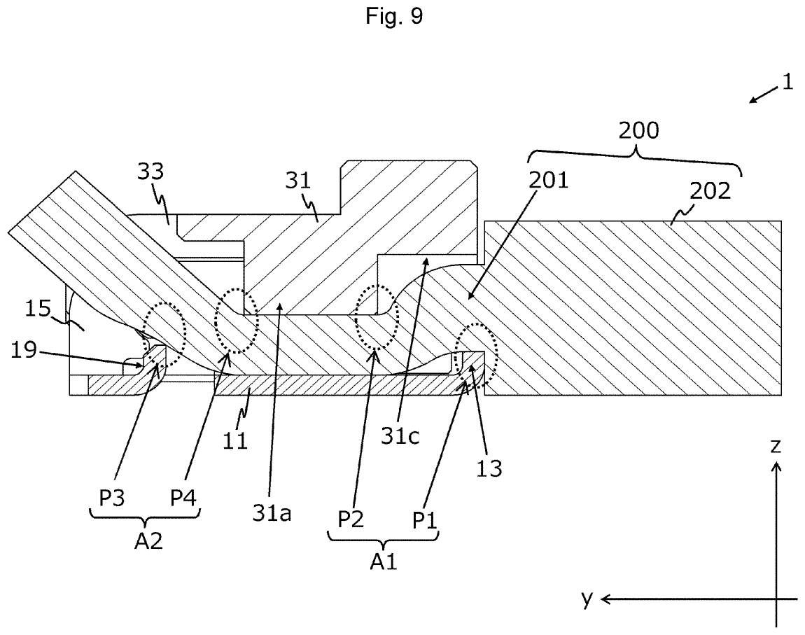

When the cable 200 is inserted into the connector 1, a first region A1 is positioned on the lower cut-away portion 13a (see FIG. 9). The first region A1 is a region that is the conductor portion 201 of the cable 200 and is close to the protection portion 202.

When the second clamp portion 30 is locked to the first clamp portion 10, a lower portion (first portion P1) of a part of the region (first region A1) which is the conductor portion 201 and is close to the protection portion 202 comes into contact with the insertion port side protrusion region 13.

At this time, the region (first region A1) of the conductor portion 201, which is close to the protection portion 202, is bent at two places by the insertion port side protrusion region 13. That is, the first region A1 of the conductor portion 201 is bent at two places of the first portion P1 and a second portion P2 to be described later (see FIG. 9).

Specifically, the first portion P1 and the second portion P2 are bent. The first portion P1 is a portion coming into contact with the lower cut-away portion 13a of the conductor portion 201. The second portion P2 is a portion of the conductor portion 201 coming into contact with the press portion 31a, and is on a side close to the insertion port side protrusion region 13. The portion (first portion P1) of the conductor portion 201 coming into contact with the lower cut-away portion 13a is bent such that a side facing the press receiving portion 11 and the lower cut-away portion 13a is recessed. That is, the first portion P1 is bent so as to protrude in a positive direction of the z direction. The portion (second portion P2) of the conductor portion 201 coming into contact with the press portion 31a and on the side close to the insertion port side protrusion region 13 is bent such that the side facing the press portion 31a is recessed. That is, the second portion P2 is bent so as to protrude in a negative direction of the z direction. As a result, a central axis of the conductor portion 201 is bent in an S shape or a crank shape between the insertion port side protrusion region 13 (one end portion of the press receiving portion 11) and the press portion 31a.

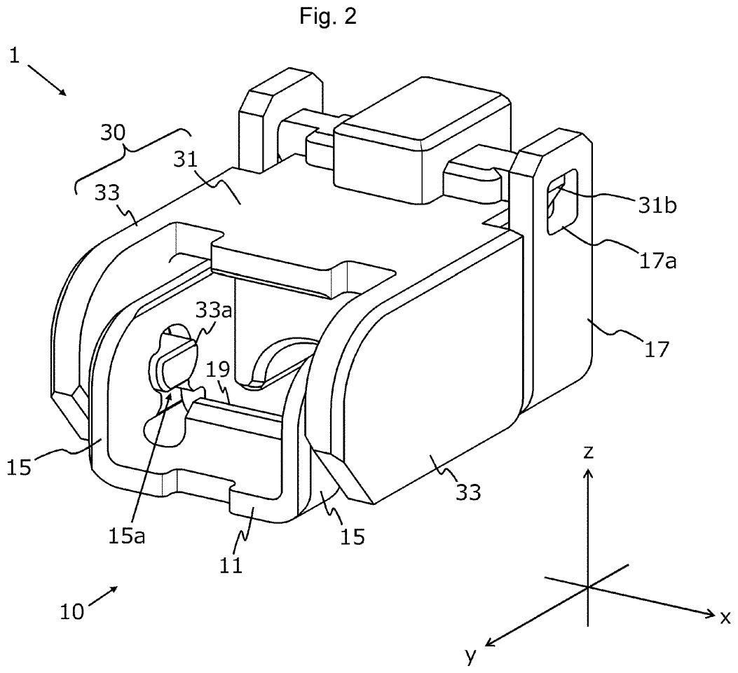

First side portions 15 have a plane (yz plane) perpendicular to the x direction (see FIG. 2). The first side portions 15 are side surfaces extending upward in the z direction (z positive direction) from both right and left ends on a rear side in the y direction of the press receiving portion 11.

The first side portions 15 are provided with first holes 15a. The first holes 15a are used as a bearing for holding rotation shafts 33a provided on side walls 33 of the second clamp portion 30.

The first holes 15a allow the second clamp portion 30 to be held by the first clamp portion 10 in a state of being rotatable about an axis parallel to the x direction.

In the first embodiment, an example in which the first side portions 15 have a plane (yz plane) perpendicular to the x direction will be described. However, the first side portions 15 may have another shape, for example, an inclined surface or a curved surface.

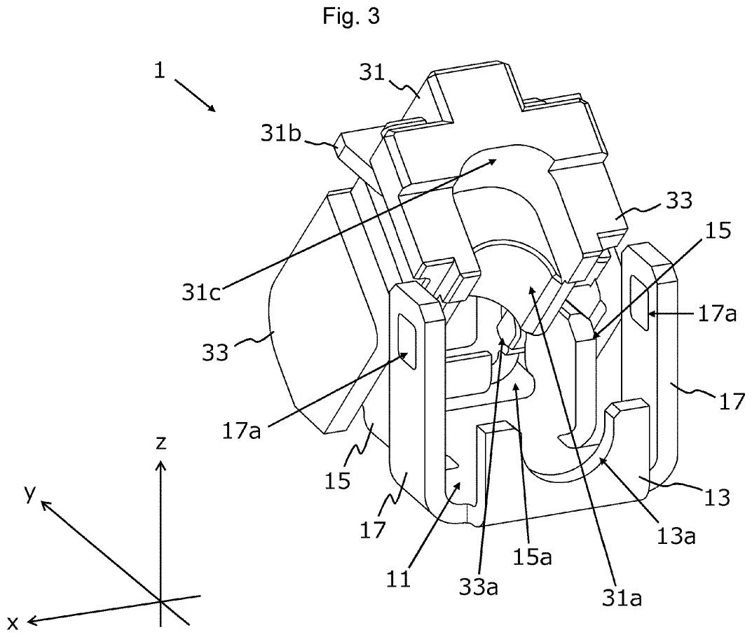

The second side portions 17 have a plane (yz plane) perpendicular to the x direction (see FIG. 3). The second side portions 17 are side surfaces extending upward in the z direction (z positive direction) from both right and left ends on a front side in the y direction of the press receiving portion 11.

The second side portions 17 are provided with locking recess portions 17a. The locking recess portions 17a are used to lock locking protrusion portions 31b provided in the upper portion 31 of the second clamp portion 30.

In the first embodiment, the locking recess portions 17a are described as holes penetrating in the x direction. However, the locking recess portions 17a may be recesses formed only on the sides facing the locking protrusion portions 31b without penetrating therethrough.

In the first embodiment, an example in which the second side portions 17 have a plane (yz plane) perpendicular to the x direction will be described. However, the second side portions 17 may have another shape, for example, an inclined surface or a curved surface.

In the first embodiment, the form has been described in which the locking protrusion portions 31b are provided in the second clamp portion 30 and the locking recess portions 17a are provided in the first clamp portion 10. However, things corresponding to the locking recess portions 17a may be provided in the second clamp portion 30, and things corresponding to the locking protrusion portions 31b may be provided in the first clamp portion 10.

The rear side protrusion region 19 has a height in a direction (z direction) which is perpendicular to a direction in which the cable 200 is inserted into the connector 1 and which faces facing a longitudinal cross section with respect to the extending direction of the conductor portion 201 (see FIG. 2).

Specifically, the rear side protrusion region 19 has a plane (xz plane) perpendicular to the y direction. The rear side protrusion region 19 is provided on a rear side in the y direction of the first clamp portion 10 (on the other end portion side of the press receiving portion 11). The rear side protrusion region 19 extends toward the conductor portion 201 upward in the z direction from the press receiving portion 11.

In the first embodiment, an example in which the rear side protrusion region 19 has a plane (xz plane) perpendicular to the y direction will be described. However, as long as the end portion comes into contact with the conductor portion 201 to fix the conductor portion 201, the rear side protrusion region 19 may have another shape, for example, an inclined surface or a curved surface.

When the cable 200 is inserted into the connector 1, a second region A2 is positioned on the rear side protrusion region 19 (see FIG. 9). The second region A2 is a region that is the conductor portion 201 of the cable 200 and is close to a distal end of the conductor portion 201.

When the second clamp portion 30 is locked to the first clamp portion 10, a lower portion (third portion P3) of a part of the region (second region A2) which is the conductor portion 201 and is close to the distal end of the conductor portion 201 comes into contact with the rear side protrusion region 19.

At this time, the region (second region A2) that is the conductor portion 201 and is close to the distal end of the conductor portion 201 is bent obliquely upward by the rear side protrusion region 19. That is, the second region A2 of the conductor portion 201 is bent at one place of a fourth portion P4 to be described later (see FIG. 9).

Specifically, the fourth portion P4 is bent. The fourth portion P4 is a portion of the conductor portion 201 coming into contact with the press portion 31a, and is on a side close to the rear side protrusion region 19. The portion (fourth portion P4) of the conductor portion 201 coming into contact with the press portion 31a and on the side close to the rear side protrusion region 19 is bent such that the side facing the press portion 31a is recessed. That is, the fourth portion P4 is bent so as to protrude in a negative direction of the z direction. As a result, the conductor portion 201 is bent between the rear side protrusion region 19 (the other end portion of the press receiving portion 11) and the press portion 31a.

A region of the press receiving portion 11 coming into contact with the conductor portion 201 is positioned between the insertion port side protrusion region 13 and the rear side protrusion region 19.

(Description of Second Clamp Portion 30)

Next, details of the second clamp portion 30 will be described.

The second clamp portion 30 includes an upper portion 31 and the side walls 33 (see FIGS. 1 to 5).

The second clamp portion 30 is made of a resin, but at least a part of the second clamp portion 30 may be made of metal.

In a case where the second clamp portion 30 is made of metal, the press portion 31a of the second clamp portion 30 may be electrically connected to the substrate 100 via the conductor portion 201.

In a case where the second clamp portion 30 is made of metal, it is desirable that an insulation material such as coating is provided on an outer surface of the second clamp portion 30 in order to execute insulation from other metal materials.

The upper portion 31 has a plane (xy plane) perpendicular to the z direction.

The press portion 31a is provided below the upper portion 31.

The press portion 31a is formed so as to be positioned between the insertion port side protrusion region 13 and the rear side protrusion region 19 when the second clamp portion 30 is locked to the first clamp portion 10 (see FIG. 9).

The press portion 31a is formed such that when the second clamp portion 30 is locked to the first clamp portion 10, a part of the conductor portion 201 of the cable 200 inserted into the connector 1 is pushed downward in the z direction (z negative direction), and the lower end of the pushed portion of the conductor portion 201 comes into contact with the press receiving portion 11.

A cross section of the region of the press portion 31a coming into contact with the conductor portion 201 as viewed from the y direction has a shape that covers at least a part of the side portion of the conductor portion 201 (see FIG. 3).

In the first embodiment, an example in which the cross section of the region of the press portion 31a coming into contact with the conductor portion 201 as viewed from the y direction has an arc shape will be described. However, the cross section may have a U shape, a V shape, or a recessed shape without one side of a quadrangle.

On the front side in the y direction and on both sides in the x direction of the upper portion 31, the locking protrusion portions 31b protruding outward in the x direction are provided (see FIG. 4).

The locking protrusion portions 31b have a triangular shape in which a width on the upper side in the z direction is wider than a width on the lower side in the z direction in the cross section as viewed from the y direction.

As a result, after the locking protrusion portions 31b are fitted into the locking recess portions 17a, a state in which the locking protrusion portion 31b are locked to the locking recess portion 17a is maintained.

This locked state is released by widening the upper portion of the second side portions 17 including the locking recess portion 17a.

In the first embodiment, an example is shown in which the locking protrusion portions 31b have a triangular shape in the cross section as viewed from the y direction. However, other shapes, for example, a hook shape may be used as long as the locking protrusion portions 31b have the shape that can be locked to the locking recess portion 17a.

When the locking protrusion portions 31b are locked to the locking recess portions 17a, the second clamp portion 30 covers the front side of the press receiving portion 11 in the y direction, the insertion port side protrusion region 13, and the first side portions 15 of the first clamp portion 10.

However, the second clamp portion 30 does not cover the rear side of the press receiving portion 11 in the y direction, the second side portions 17, and the rear side protrusion region 19.

Therefore, the upper portion of the second side portions 17 can be widened even in a state in which the second clamp portion 30 is locked to the first clamp portion 10.

Since the distal end portion (the rear side in the y direction) is opened, it is possible to visually recognize, from the rear side in the y direction, whether or not the conductor portion 201 of the cable 200 is clamped between the second clamp portion 30 and the first clamp portion 10.

An upper cut-away portion 31c covering the conductor portion 201 from above is provided in a lower portion of the upper portion 31 and at a position facing the insertion port side protrusion region 13 in the z direction when the second clamp portion 30 is locked to the first clamp portion 10 (see FIG. 1).

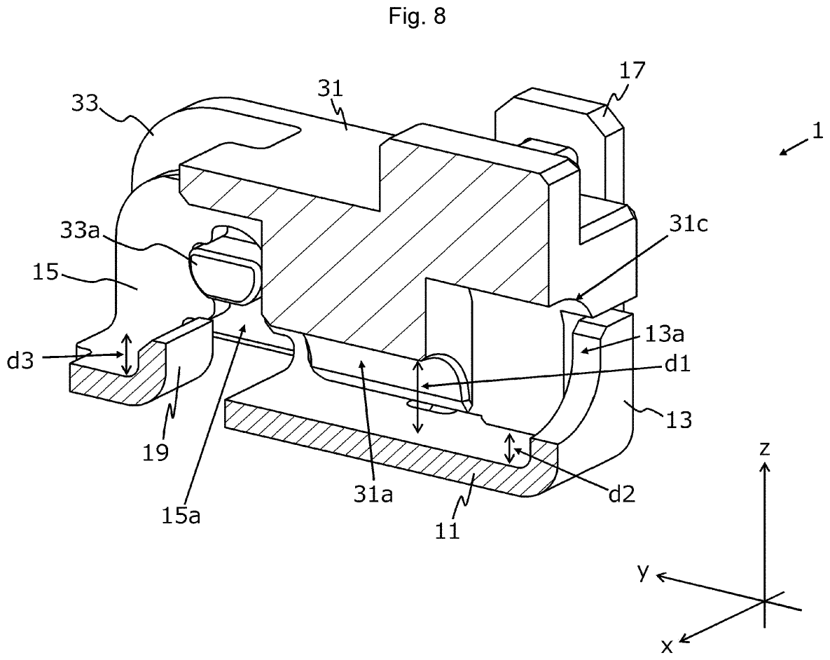

A region of the upper cut-away portion 31c coming into contact with the conductor portion 201 is formed at a position higher than the region of the press portion 31a coming into contact with the conductor portion 201 in the z direction (see FIG. 8).

In a case where an electronic device that emits light, such as an LED, is arranged in the vicinity of the connector 1, it is desirable that the outer surfaces (surfaces exposed to the outside) of the upper portion 31 and the side walls 33, and the protection portion 202 of the cable 200 are coated or made of a material having a higher reflectance than other portions (for example, inner surface).

Accordingly, it is possible to reflect the light emitted by the electronic device to enhance a light emission effect.

(Shape of Respective Portions)

In the first embodiment, sizes of the first clamp portion 10 and the second clamp portion 30, and a positional relationship of the respective portions are determined such that any of the two types of cables 200 having different thicknesses can be attached to the connector 1.

In particular, a first distance d1, a second distance d2, and a third distance d3 are considered (see FIG. 8).

The first distance d1 is a distance between a portion (upper end) farthest from the press receiving portion 11 in a region of the press portion 31a coming into contact with the conductor portion 201 when locked and the press receiving portion 11 in the z direction.

The second distance d2 is a distance between a portion (lower end) closest to the press receiving portion 11 and the press receiving portion 11 in the z direction in a region of the lower cut-away portion 13a coming into contact with the conductor portion 201.

The third distance d3 is a distance between a portion (lower end) closest to the press receiving portion 11 and the press receiving portion 11 in the z direction in a region of the rear side protrusion region 19 coming into contact with the conductor portion 201.

Specifically, the sizes of the first clamp portion 10 and the second clamp portion 30 and the positional relationship of the respective portions are determined as follows.

When the conductor portion 201 of the cable 200 having the conductor portion 201 having a large diameter is inserted into the connector 1 and the first clamp portion 10 and the second clamp portion 30 clamped the conductor portion 201, the conductor portion 201 comes into contact with the press portion 31a and the press receiving portion 11 in a state in which the conductor portion 201 is crushed by the press portion 31a and the press receiving portion 11. In a state in which the lower cut-away portion 13a comes into contact with the conductor portion 201, the central axis of the conductor portion 201 is bent in an S shape or a crank shape between the press portion 31a and the lower cut-away portion 13a. The conductor portion 201 is bent between the press portion 31a and the rear side protrusion region 19 in a state in which the rear side protrusion region 19 comes into contact with the conductor portion 201 (see FIG. 9).

The sizes of the first clamp portion 10 and the second clamp portion 30 and the positional relationship of the respective portions are determined as follows.

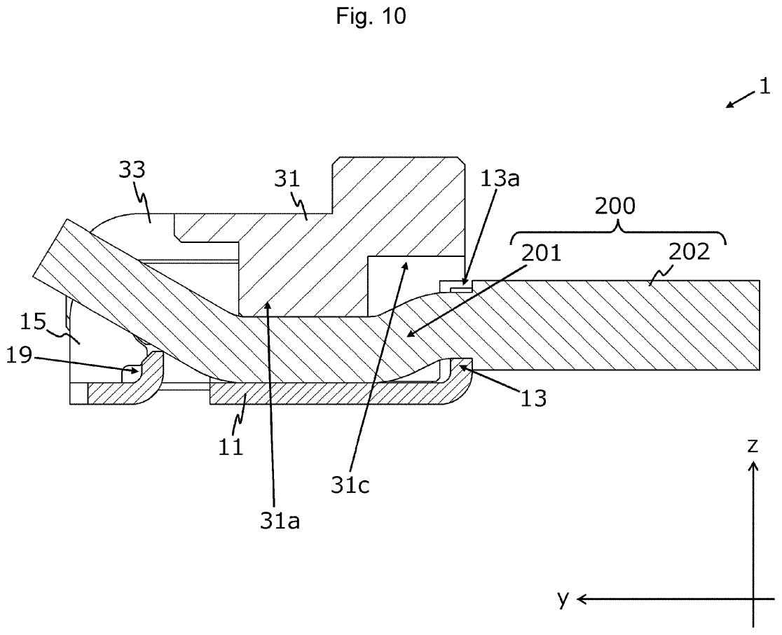

When the conductor portion 201 of the cable 200 having the conductor portion 201 having a small diameter is inserted into the connector 1 and the first clamp portion 10 and the second clamp portion 30 clamped the conductor portion 201, the conductor portion 201 comes into contact with the press portion 31a and the press receiving portion 11. In a state in which the lower cut-away portion 13a comes into contact with the conductor portion 201, the central axis of the conductor portion 201 is bent in an S shape or a crank shape between the press portion 31a and the lower cut-away portion 13a. The conductor portion 201 is bent between the press portion 31a and the rear side protrusion region 19 in a state in which the rear side protrusion region 19 comes into contact with the conductor portion 201 (see FIG. 10).

The distance (first distance d1) between a portion (upper end) farthest from the press receiving portion 11 in a region of the press portion 31a coming into contact with the conductor portion 201 when locked and the press receiving portion 11 in the z direction is shorter than the diameter of the conductor portion 201 of the cable 200 connected to the connector 1.

The cross section of the region surrounded by the press portion 31a and the press receiving portion 11 as viewed from the y direction has a cross-sectional area equal to or larger than the cross-sectional area of a plurality of the stranded wires constituting the conductor portion 201 as viewed from the y direction.

Specifically, the cross section of the region surrounded by the press portion 31a and the press receiving portion 11 as viewed from the y direction has substantially the same cross-sectional area as the cross-sectional area of a plurality of the stranded wires constituting the conductor portion 201 having a large diameter as viewed from the y direction. The cross section of the region surrounded by the press portion 31a and the press receiving portion 11 as viewed from the y direction is slightly larger than the cross-sectional area of a plurality of the stranded wires constituting the conductor portion 201 having a small diameter as viewed from the y direction.

The cross-sectional area of a plurality of the stranded wires as viewed from the y direction herein excludes an area of a gap between the stranded wire and the adjacent stranded wire.

The protrusion amount (second distance d2) of the region (lower cut-away portion 13a) of the insertion port side protrusion region 13 coming into contact with the conductor portion 201 from the press receiving portion 11 in the z direction is smaller than the protrusion amount (third distance d3) of the region of the rear side protrusion region 19 coming into contact with the conductor portion 201 from the press receiving portion 11 in the z direction.

(Attachment Procedure of Cable 200)

Next, a procedure for attaching the cable 200 to the connector 1 will be described with reference to FIGS. 5 and 11 to 14.

The first clamp portion 10 is fixed to the substrate 100 in advance.

As illustrated in FIG. 5, the rotation shaft 33a of the second clamp portion 30 is held in the first hole 15a of the first clamp portion 10 in a state in which the locking protrusion portions 31b are locked to the locking recess portions 17a.

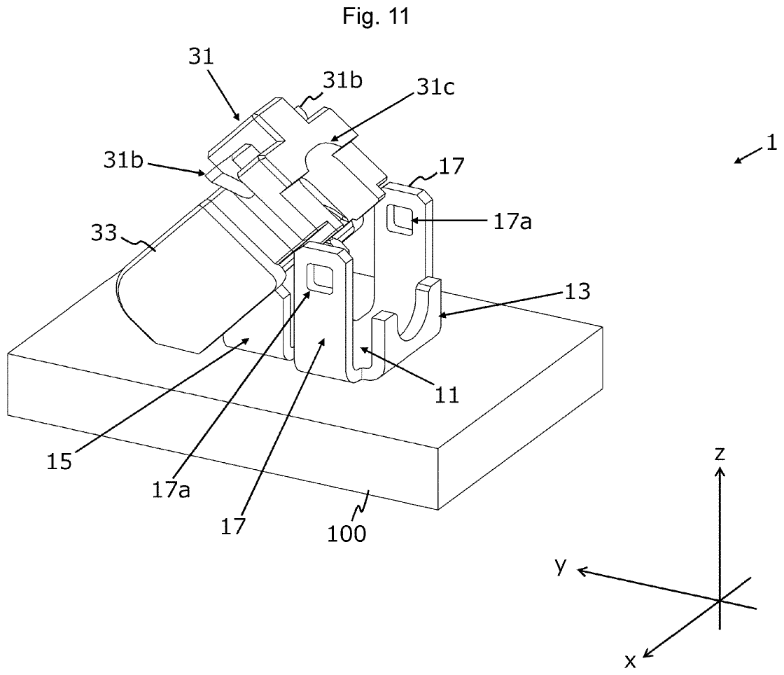

First, the upper portion of the second side portions 17 is widened outward in the x direction, and the state in which the locking protrusion portions 31b are locked to the locking recess portions 17a is released. Then, the front side of the second clamp portion 30 in the y direction is lifted away from the first clamp portion 10, and an insertion port side (front side in the y direction) of the connector 1 is in an opened state (first state) (see FIG. 11).

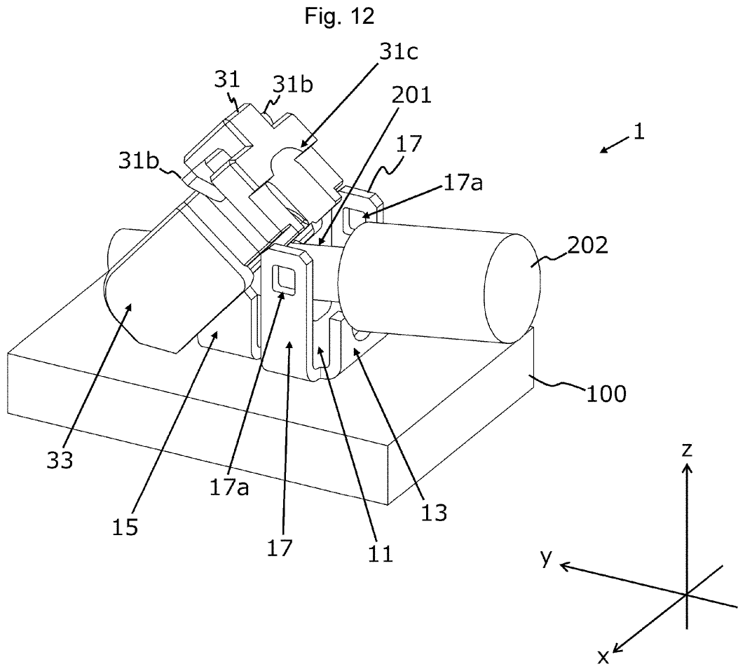

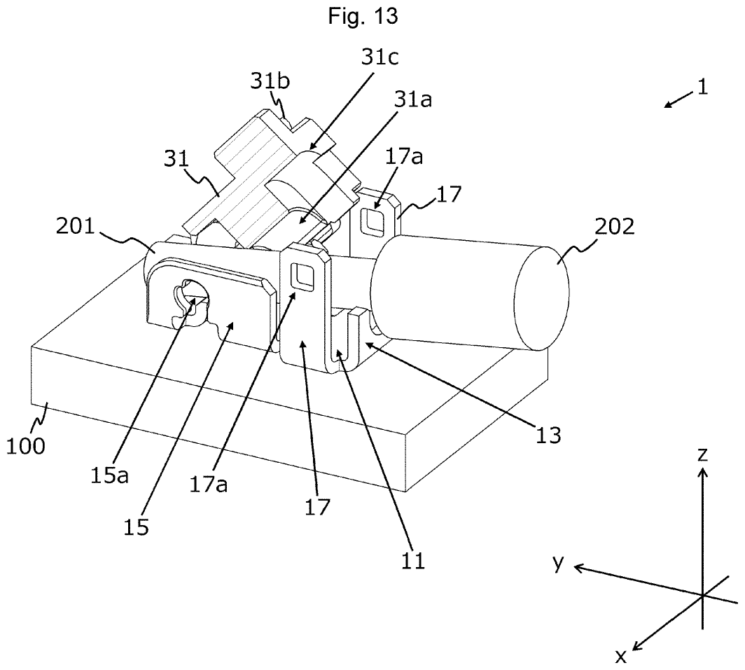

Next, the cable 200 is inserted between the first clamp portion 10 and the second clamp portion 30 such that the distal end of the conductor portion 201 is positioned on the rear side in the y direction and on the upper side in the z direction with respect to the rear side protrusion region 19 and a stripped portion of the conductor portion 201 in the vicinity of the portion coated with the protection portion 202 is positioned on the upper side of the lower cut-away portion 13a in the z direction (insertion step, second state, see FIGS. 12 and 13).

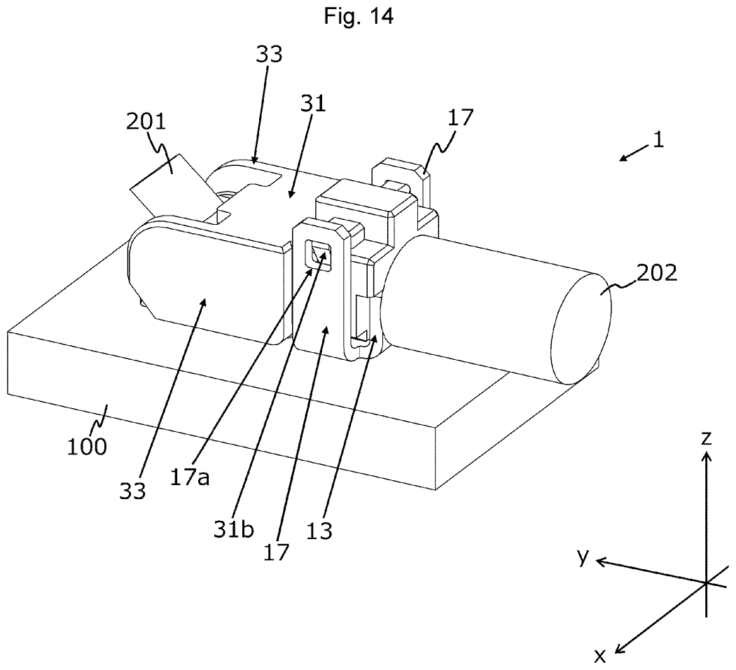

Next, the front side of the second clamp portion 30 in the y direction is brought close to the first clamp portion 10 such that the locking protrusion portions 31b are locked to the locking recess portions 17a (fixing step, third state, see FIG. 14).

At this time, the press portion 31a presses the conductor portion 201 downward in the z direction (z negative direction), the conductor portion 201 comes into contact with the press receiving portion 11, and the conductor portion 201 is bent in a state in which the lower cut-away portion 13a comes into contact with the conductor portion 201 and the rear side protrusion region 19 comes into contact with the conductor portion 201.

As a result, the cable 200 is attached to the connector 1.

(Procedure for Detaching Cable 200)

Next, a procedure for detaching the cable 200 from the connector 1 from the third state will be described with reference to FIGS. 11 to 14.

First, the upper portion of the second side portions 17 is widened outward in the x direction from the third state (see FIG. 14).

As a result, the state in which the locking protrusion portions 31b are locked to the locking recess portions 17a is released.

Next, the front side of the second clamp portion 30 in the y direction is lifted away from the first clamp portion 10, and an insertion port side (front side in the y direction) of the connector 1 is in an opened state.

The protection portion 202 of the cable 200 is lifted, and a state in which the conductor portion 201 comes into contact with the lower cut-away portion 13a or the like is released (releasing step, second state, see FIGS. 12 and 13).

Next, the cable 200 is pulled away from the connector 1, that is, the cable 200 is pulled toward the front side in the y direction (removal step, first state, see FIG. 11).

As a result, the cable 200 is detached from connector 1.

### EFFECTS OF THE INVENTION

The cable 200 can be fixed to the connector 1 by locking the second clamp portion 30 to the first clamp portion 10 and clamping the conductor portion 201 between the press portion 31a and the press receiving portion 11.

At this time, the central axis of the conductor portion 201 is bent in an S shape or a crank shape between the insertion port side protrusion region 13 and the press portion 31a. Therefore, as compared with a form in which a region bent in the crank shape is not provided, it becomes hard to be detached and the connection state can be firmly maintained.

The conductor portion 201 is bent between the rear side protrusion region 19 and the press portion 31a. Therefore, as compared with a form in which a bent region is not provided, it becomes hard to be detached and the connection state can be firmly maintained.

By providing the rear side protrusion region 19, the cable 200 can be inserted between the first clamp portion 10 and the second clamp portion 30 such that the distal end of the conductor portion 201 is positioned on the rear side in the y direction and on the upper side in the z direction with respect to the rear side protrusion region 19. Therefore, the insertion position when the conductor portion 201 is inserted into the connector 1 can be easily understood as compared with a form in which the rear side protrusion region 19 is not provided.

The protrusion amount (third distance d3) of the region of the rear side protrusion region 19 coming into contact with the conductor portion 201 in the z direction is larger than the protrusion amount (second distance d2) of the region of the insertion port side protrusion region 13 coming into contact with the conductor portion 201 in the z direction. Therefore, the distal end portion of the conductor portion 201 can be bent more than the other region. Accordingly, the cable 200 cannot be easily removed from the connector 1 as compared with a form in which the distal end portion of the conductor portion 201 is not largely bent.

The second clamp portion 30 is locked to the first clamp portion 10. Therefore, when the locked state is released, the second clamp portion 30 is separated from the first clamp portion 10, and the cable 200 can be easily removed from the connector 1.

The press portion 31a and the lower cut-away portion 13a of the insertion port side protrusion region 13 has a shape covering a side portion of the conductor portion 201 formed of the stranded wires. Therefore, it is possible to prevent the conductor portion 201 from being scattering after being pressed.

An opening is provided on both the front side in the y direction and the rear side in the y direction between the second clamp portion 30 and the first clamp portion 10. Therefore, it is possible to confirm an attachment state or the like of the conductor portion 201 before locking or after locking.

The conductor portion 201 can be brought into contact with the first clamp portion 10 at a plurality of places (the press receiving portion 11, the insertion port side protrusion region 13, and the rear side protrusion region 19). Therefore, connection reliability can be improved as compared with a form in which contact is made at one point.

The first clamp portion 10 including the press receiving portion 11 is fixed to the substrate 100, and the second clamp portion 30 is rotatably held by the first clamp portion 10. Therefore, the second clamp portion 30 cannot be removed from the substrate 100, and a loss of the second clamp portion 30 can be prevented.

### Second Embodiment

In the first embodiment, a form has been described in which the second clamp portion 30 is rotatably held by the first clamp portion 10. However, the second clamp portion 30 may be held by the first clamp portion 10 in a slidable state in the z direction.

In the first embodiment, a form has been described in which the second clamp portion 30 is locked to the first clamp portion 10. However, the second clamp portion 30 may be locked to a housing holding the first clamp portion 10.

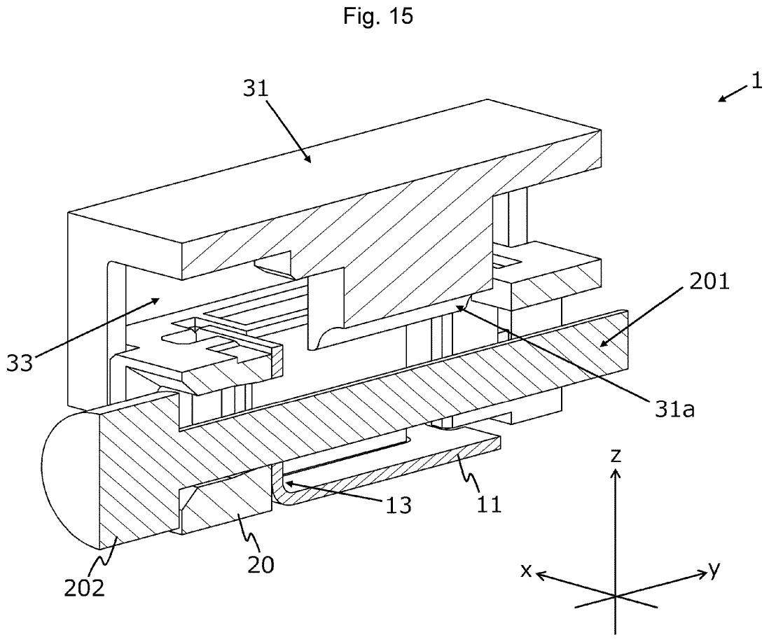

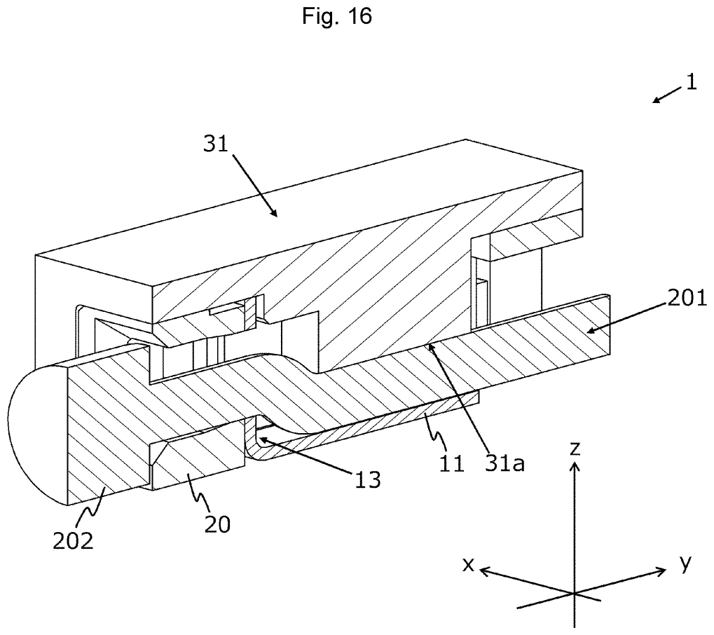

FIGS. 15 and 16 illustrates an example (second embodiment) in which the second clamp portion 30 is locked to a housing 20 holding the first clamp portion 10 in a slidable state in the z direction.

### Third Embodiment

In the first embodiment, a form has been described in which the first clamp portion 10 is attached to the substrate 100. However, the connector 1 may be used for connection with another electronic device in a state in which the first clamp portion 10 is not attached to the substrate 100.

In the first embodiment, a form has been described in which the first clamp portion 10 is fixed to the second clamp portion 30 by locking. However, the first clamp portion 10 may be fixed to the second clamp portion 30 by a fixing method different from the locking method.

In the first embodiment, a form has been described in which the region (press portion 31a) of the second clamp portion 30 that presses the conductor portion 201 and the regions (locking protrusion portions 31b) of the second clamp portion 30 used for fixing the second clamp portion 30 to the first clamp portion 10 are integrally formed. However, these may be configured separately.

In the first embodiment, a form has been described in which the press portion 31a covers the conductor portion 201. However, the press receiving portion 11 may cover the conductor portion 201.

In the first embodiment, a form has been described in which the insertion port side protrusion region 13 and the rear side protrusion region 19 extend in the z direction from the press receiving portion 11, and are integrally formed with the press receiving portion 11. However, the insertion port side protrusion region 13 and the rear side protrusion region 19 may be formed separately from the press receiving portion 11.

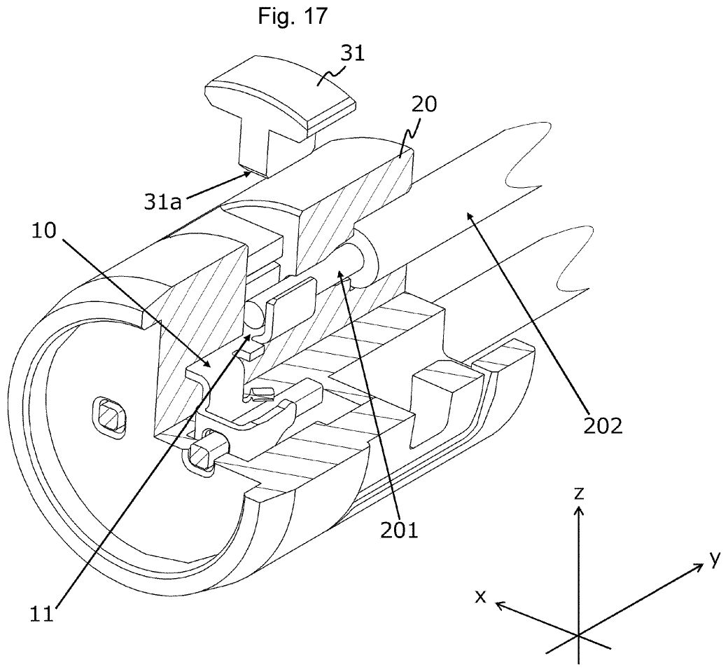

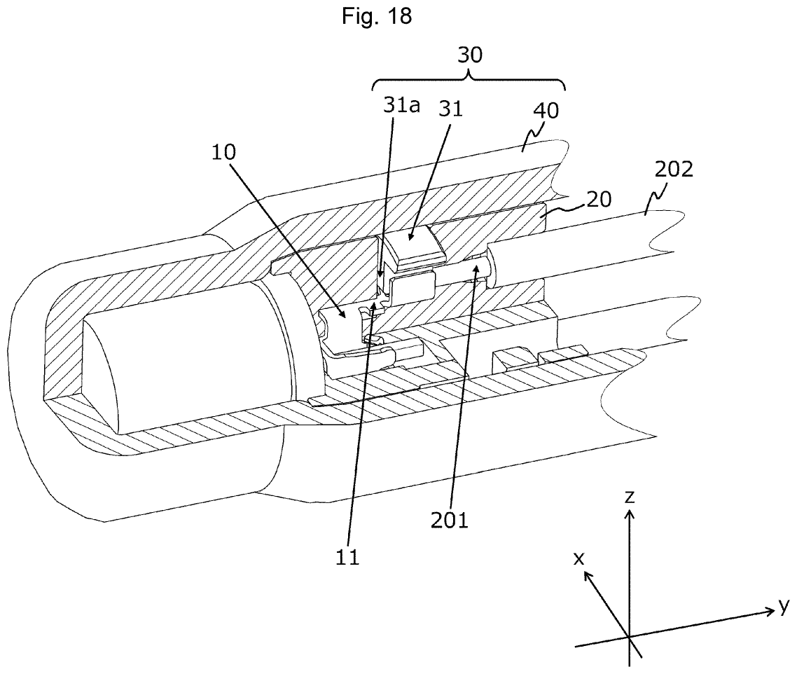

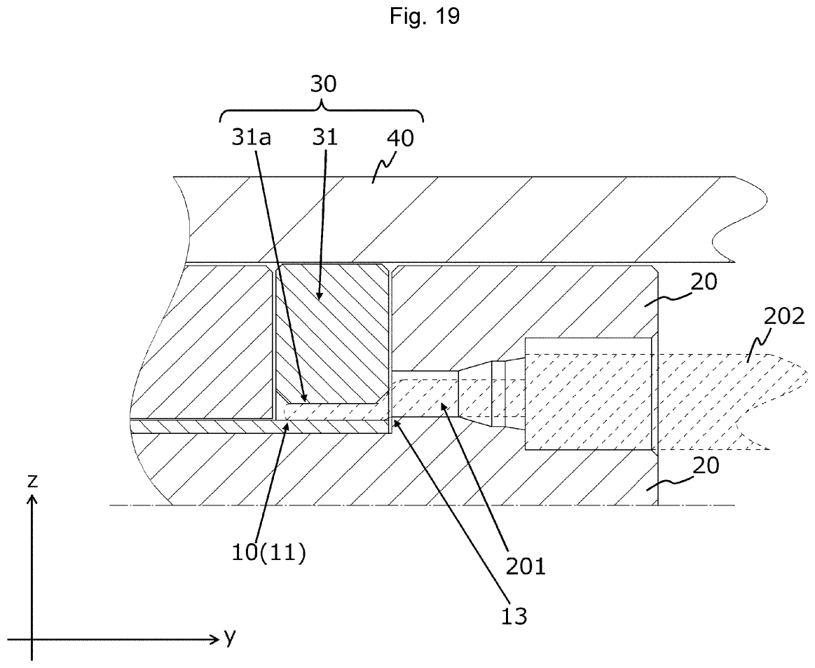

FIGS. 17 to 19 illustrate an example (third embodiment) in which the first clamp portion 10 is connected to a terminal (foot) extending from an LED element instead of the substrate 100.

The third embodiment describes an example in which the first clamp portion 10 is fixed to the second clamp portion 30 by a fixing method different from the locking method. The third embodiment describes an example in which a pressing region (press portion 31a) and a region used for fixing the first clamp portion 10 are formed separately. Specifically, the second clamp portion 30 has a hollow cylindrical cover 40. The cover 40 is separate from the press portion 31a and covers the press portion 31a and the housing 20 that holds the first clamp portion 10.

In the third embodiment, by covering the housing 20 and the press portion 31a with the cover 40, the conductor portion 201 is clamped between the press portion 31a and the press receiving portion 11.

By covering the housing 20 and the press portion 31a with the cover 40, the first clamp portion 10 and the second clamp portion 30 are fixed.

The third embodiment describes an example in which the press receiving portion 11 has a side surface extending in the z direction and covers at least a part of the side portion of the conductor portion 201. That is, the cross section of the region of the press receiving portion 11 coming into contact with the conductor portion 201 as viewed from the y direction has a shape that covers the side portion of the conductor portion 201.

The third embodiment describes an example in which a step portion is provided in a region in which the housing 20 comes into contact with one end portion of the press receiving portion 11, and by this step portion, the insertion port side protrusion region 13 is formed on a side on which the one end portion of the press receiving portion 11 is positioned.

### Other Embodiments

In the first embodiment to the third embodiment, an example has been described in which a pressing direction of the press portion 31a and the press receiving portion 11 is the z direction (up and down direction), but the pressing direction may be another direction such as the x direction (right and left direction).

Some embodiments of the present invention have been described, but these embodiments have been presented as examples, and are not intended to limit the scope of the invention. These embodiments can be implemented in various other forms, and various omissions, substitutions, and changes can be made without departing from the gist of the invention. These embodiments and modifications thereof are included in the scope and gist of the invention and are included in the invention described in the claims and the equivalent scope thereof.

### REFERENCE SIGNS LIST

1 connector
10 first clamp portion
11 press receiving portion (bottom surface portion)
13 insertion port side protrusion region
13a lower cut-away portion
15 first side portion (side portion for a bearing)
15a first hole
17 second side portion (side portion for engagement)
17a locking recess portion
19 rear side protrusion region
20 housing
30 second clamp portion
31 upper portion
31a press portion (press arrow)
31b locking protrusion portion
31c upper cut-away portion
33 side wall
33a rotation shaft
40 cover
100 substrate
200 cable
201 conductor portion (linear conductor)
202 protection portion
A1 first region
A2 second region
d1 first distance
d2 second distance
d3 third distance
P1 first portion
P2 second portion
P3 third portion
P4 fourth portion

1. A connector comprising:
a first clamp portion including a press receiving portion; and
a second clamp portion including a press portion,
wherein at least one of the press receiving portion and the press portion includes metal,
when the second clamp portion is fixed to the first clamp portion or a housing that holds the first clamp portion, a linear conductor inserted from one end portion side of the press receiving portion is clamped between the press portion and the press receiving portion, comes into contact with the press portion and the press receiving portion, and is bent between the one end portion and the press portion,
the first clamp portion includes an insertion port side protrusion region on the one end portion side,
the insertion port side protrusion region extends in a direction perpendicular to an extending direction of the linear conductor, and
a region of the insertion port side protrusion region coming into contact with the linear conductor has a first cut-away portion covering the linear conductor from a first side.

2. The connector according to claim 1,
wherein the first clamp portion includes an insertion port side protrusion region on the one end portion side, and a rear side protrusion region on the other end portion side of the press receiving portion,
the insertion port side protrusion region and the rear side protrusion region extend toward the linear conductor,
a region of the press receiving portion coming into contact with the linear conductor is positioned between the insertion port side protrusion region and the rear side protrusion region,
when the second clamp portion is fixed to the first clamp portion or the housing, the linear conductor is bent between the insertion port side protrusion region and the press portion and between the rear side protrusion region and the press portion, under the condition in which the linear conductor comes into contact with the insertion port side protrusion region and the rear side protrusion region, and
a protrusion amount of a region of the insertion port side protrusion region coming into contact with the linear conductor from the press receiving portion is smaller than a protrusion amount of a region of the rear side protrusion region coming into contact with the linear conductor from the press receiving portion.

3.-18. (canceled)

19. A connector comprising:
a first clamp portion including a press receiving portion;
a second clamp portion including a press portion; and
a housing holding the first clamp portion,
wherein the second clamp portion has a cover covering the housing and the press portion,
at least one of the press receiving portion and the press portion includes metal, and
when the second clamp portion is fixed to a housing that holds the first clamp portion, a linear conductor inserted from one end portion side of the press receiving portion is clamped between the press portion and the press receiving portion, comes into contact with the press portion and the press receiving portion,
by covering the housing and the press portion with the cover, the linear conductor is clamped between the press portion and the press receiving portion, and
by covering the housing and the press portion with the cover, the first clamp portion and the second clamp portion are fixed.

20. The connector according to claim 2,
wherein the press receiving portion, the insertion port side protrusion region, and the rear side protrusion region include metal, and
when the second clamp portion is fixed to the first clamp portion or the housing, the linear conductor comes into contact with the press receiving portion, the insertion port side protrusion region, and the rear side protrusion region.

21. The connector according to claim 1,
wherein the linear conductor is formed of a stranded wire,
a cross section of a region of the press portion coming into contact with the linear conductor as viewed from the one end portion side has a shape covering at least a part of a side portion of the linear conductor, and
when the second clamp portion is fixed to the first clamp portion or the housing, a distance between a portion farthest from the press receiving portion in a region of the press portion coming into contact with the linear conductor and the press receiving portion is shorter than a diameter of the linear conductor.

22. The connector according to claim 1,
wherein the linear conductor is formed of a stranded wire,
a cross section of a region of the press receiving portion coming into contact with the linear conductor as viewed from the one end portion side has a shape covering at least a part of a side portion of the linear conductor, and
when the second clamp portion is fixed to the first clamp portion or the housing, a distance between a portion farthest from the press portion in a region of the press receiving portion coming into contact with the linear conductor and the press portion is shorter than a diameter of the linear conductor.

23. The connector according to claim 1,
wherein the linear conductor is formed of a stranded wire, and
when the second clamp portion is fixed to the first clamp portion or the housing, a cross section of a region surrounded by the press portion and the press receiving portion as viewed from the one end portion side has a cross-sectional area equal to or larger than a cross-sectional area of a plurality of the stranded wires constituting the linear conductor as viewed from the one end portion side.

24. The connector according to claim 1,
wherein the second clamp portion has a cover covering the housing and the press portion,
when the second clamp portion is fixed to a housing that holds the first clamp portion, a linear conductor inserted from one end portion side of the press receiving portion is clamped between the press portion and the press receiving portion, comes into contact with the press portion and the press receiving portion,
by covering the housing and the press portion with the cover, the linear conductor is clamped between the press portion and the press receiving portion, and
by covering the housing and the press portion with the cover, the first clamp portion and the second clamp portion are fixed.

25. The connector according to claim 1,
wherein the first clamp portion includes a first side portion, and
the first side portion rotatably holds the second clamp portion.

26. The connector according to claim 25,
wherein the second clamp portion is fixed to the first clamp portion or the housing by locking,
the first clamp portion includes a second side portion on a side closer to the one end portion than the first side portion, and
the second side portion includes protrusions or recesses for locking the second clamp portion.

27. The connector according to claim 26, wherein when the second clamp portion is fixed to the first clamp portion or the housing, the second clamp portion covers the first side portion and a side close to the one end portion, and does not cover the second side portion and a side opposite to the side close to the one end portion.

28. The connector according to claim 25, wherein the press receiving portion is fixed to a substrate.

29. The connector according to claim 1, wherein when the second clamp portion is fixed to the first clamp portion or the housing, a central axis of the linear conductor is bent in an S shape or a crank shape between the one end portion and the press portion.

30. The connector according to claim 1, wherein the linear conductor is removable.

31. The connector according to claim 1,
wherein the first clamp portion includes an insertion port side protrusion region on the one end portion side and a rear side protrusion region on the other end portion side of the press receiving portion, and
a protrusion amount of a region of the insertion port side protrusion region coming into contact with the linear conductor from the press receiving portion is smaller than a protrusion amount of a region of the rear side protrusion region coming into contact with the linear conductor from the press receiving portion.

32. The connector according to claim 1,
wherein the first clamp portion includes an insertion port side protrusion region on the one end portion side and a rear side protrusion region on the other end portion side of the press receiving portion, and
when the second clamp portion is fixed to the first clamp portion or the housing, the linear conductor comes into contact with the press receiving portion, the insertion port side protrusion region, and the rear side protrusion region.

33. The connector according to claim 1,
wherein the first clamp portion includes an insertion port side protrusion region on the one end portion side, and a rear side protrusion region on the other end portion side of the press receiving portion, and
a protrusion amount of a region of the insertion port side protrusion region coming into contact with the linear conductor from the press receiving portion is smaller than a protrusion amount of a region of the rear side protrusion region coming into contact with the linear conductor from the press receiving portion, and
when the second clamp portion is fixed to the first clamp portion or the housing, the linear conductor comes into contact with the press receiving portion, the insertion port side protrusion region, and the rear side protrusion region.

34. The connector according to claim 1, wherein openings are provided between the second clamp portion and the first clamp portion and on one end portion side and the other end portion side in an insertion direction of the conductor, and
a distal end of the linear conductor protrudes from the opening on the other end portion side, when the second clamp portion is fixed to the first clamp portion.

35. The connector according to claim 1, wherein the second clamp portion includes a second cut-away portion, and
the second cut-away portion covers the linear conductor from a second side which is an opposite side of the first side and at a position facing the insertion port side protrusion region when the second clamp portion is fixed to the first clamp portion.
